(19) United States
(12) Patent Application Publication
(10) Pub. No.: US 2018/0094484 A1
(43) Pub. Date: Apr. 5, 2018

(54) FOLDING LADDER

(71) Applicant: Ballymore Company, Inc., Parkesburg, PA (US)

(72) Inventors: William F. Frame, Parkesburg, PA (US); Ronald E. Bernard, Coatesville, PA (US)

(21) Appl. No.: 15/723,779

(22) Filed: Oct. 3, 2017

Related U.S. Application Data
(60) Provisional application No. 62/403,616, filed on Oct. 3, 2016.

(51) Int. Cl. E06C 1/20; E06C 7/42

(52) U.S. Cl. CPC E06C 1/20; E06C 7/42

(57) ABSTRACT

A folding ladder for use with a compact container includes a stair section assembly comprising a plurality of steps connected between two parallel stringer sections, the stair section assembly having a front end and a back end. The ladder also includes a base having casters, the base being pivotably attached to the front end of the stair section and a vertical upright support pivotably attached to the back end of the stair section a one end and non-securedly attached to the base at an opposite end. A first brace is pivotably attached to the stair section at one end and detachably secured at the vertical upright support at an opposite end. A second brace pivotably attached to the stair section at one end and detachably secured at the base at an opposite end, whereby the ladder may be folded into a compact configuration for shipping or storage.

### CROSS REFERENCE TO RELATED APPLICATIONS

This application also claims the benefit of U.S. Provisional Application No. 62/403,616, filed Oct. 3, 2016. The entire disclosures of which is incorporated herein by reference.

### STATEMENT REGARDING FEDERALLY SPONSORED RESEARCH OR DEVELOPMENT

The present invention was not developed with the use of any Federal Funds, but was developed independently by the inventors.

### BACKGROUND

### Field

The Invention relates to a ladder, and more specifically to a ladder that is configured to be folded that facilitates efficient shipping, transportation in a container, and storage of the ladder. Accordingly, there is a need for a new and improved folding ladder which facilitates folding for shipping in compact containers and storage.

There has been a long-standing problem in the ladder industry that rolling ladders are difficult to package and ship. They are built to rigorous industry safety standards that are specified in ANSI 14.7. Rolling ladders typically comprise a welded stair section. Typically, the top step of the ladder is substantially deeper in depth than the lower steps. This deeper step allows a larger platform for a user to stand on.

Unfortunately, the deeper step makes rolling ladders more cumbersome to package, ship, and store. While the support frames, hand rails and wheels of the ladder may be easily removed for shipping, the deeper top step still protrudes up when the welded stair section is laid flat. This increases the shipping container size and makes the boxes difficult to stack for shipping.

Accordingly, there is a need for a new and improved folding ladder which facilitates folding for shipping in compact containers and storage.

### SUMMARY

Disclosed herein is a folding ladder for use with a compact container includes a stair section assembly comprising a plurality of steps connected between two parallel stringer sections, the stair section assembly having a front end and a back end. The ladder also includes a base having casters, the base being pivotably attached to the front end of the stair section and a vertical upright support pivotably attached to the back end of the stair section a one end and non-securedly attached to the base at an opposite end. A first brace is pivotably attached to the stair section at one end and detachably secured at the vertical upright support at an opposite end. A second brace pivotably attached to the stair section at one end and detachably secured at the base at an opposite end, whereby the ladder may be folded into a compact configuration for shipping or storage.

The vertical upright support may include a handrail assembly at its top end which interacts with a top step of the stair section. The stair section may include a foldable handrail which attaches to the handrail assembly.

The connection between the base and vertical may not include fasteners. The base and vertical upright support may nest together and stay in place once the first and second rails are fixedly connected. The fold-down handrails may rotate into place and connect to the handrail assembly. The stair section may include a locking bottom step and the top step has a wider depth relative to the remaining steps.

### BRIEF DESCRIPTION OF THE DRAWINGS

The embodiments will be described in detail with reference to the following drawings in which like reference numerals refer to like elements wherein:

FIG. 1 shows a perspective view of a folding ladder in accordance with the present invention.

FIG. 2 shows a side view of the ladder of FIG. 1.

FIG. 3 shows a back view of the ladder of FIG. 1.

FIG. 4 shows a perspective view of the ladder of FIG. 1 in a folded position.

FIG. 5 shows a side view of the ladder of FIG. 1 in a folded position.

FIG. 6 shows a back view of the ladder of FIG. 1 in a folded position.

### DETAILED DESCRIPTION

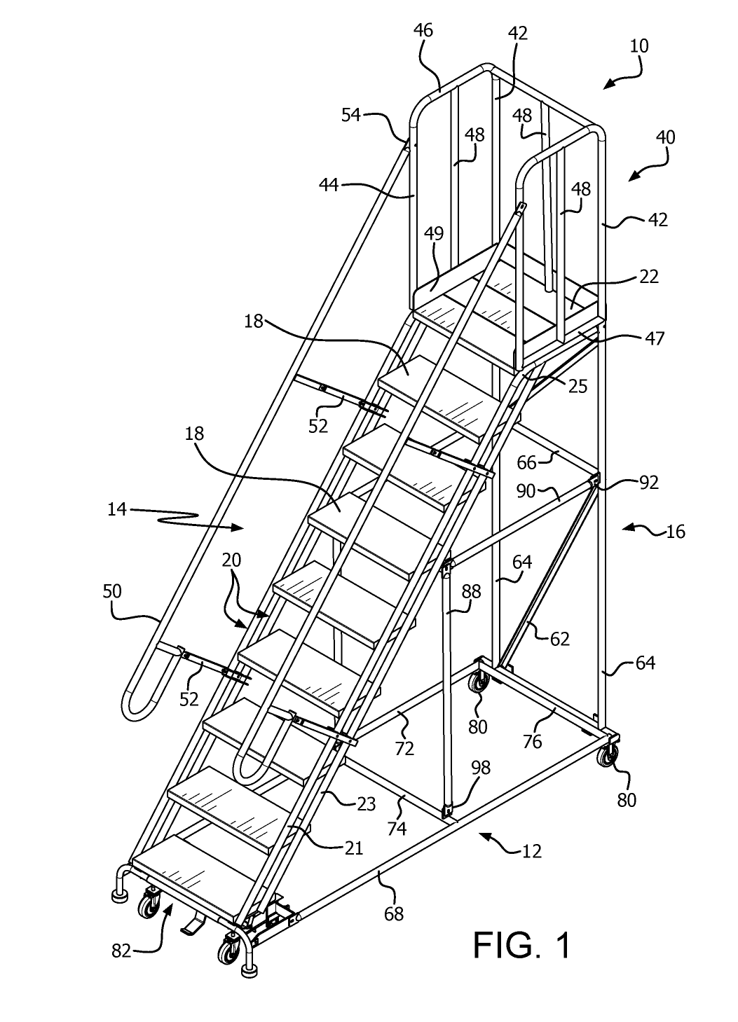

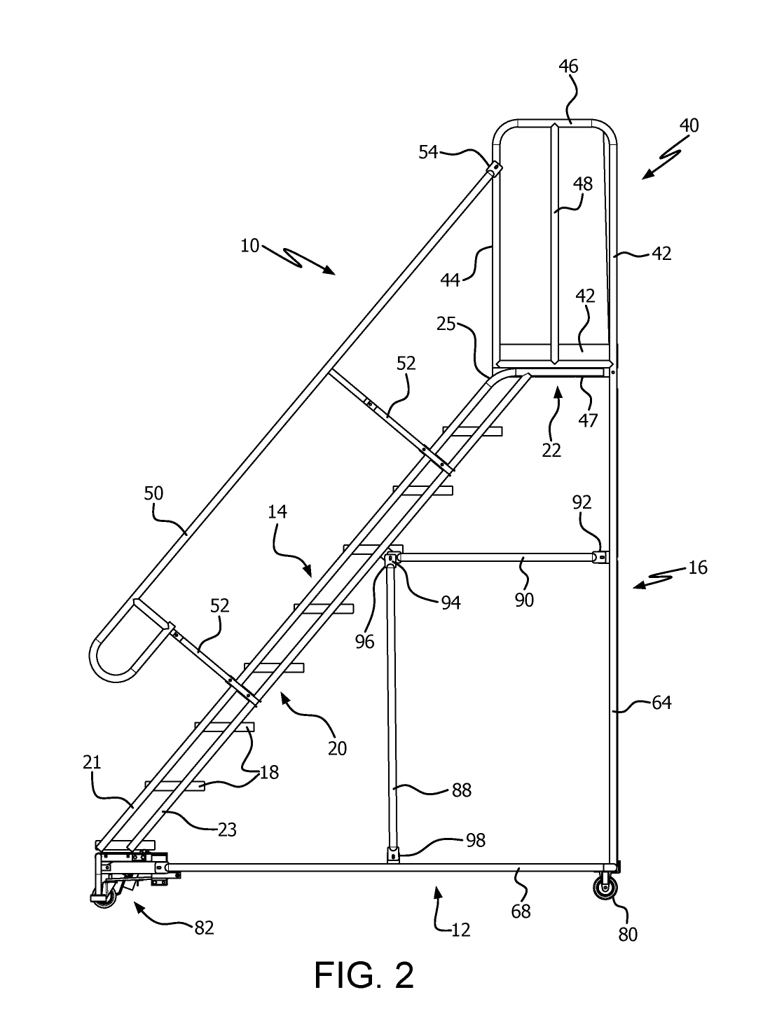

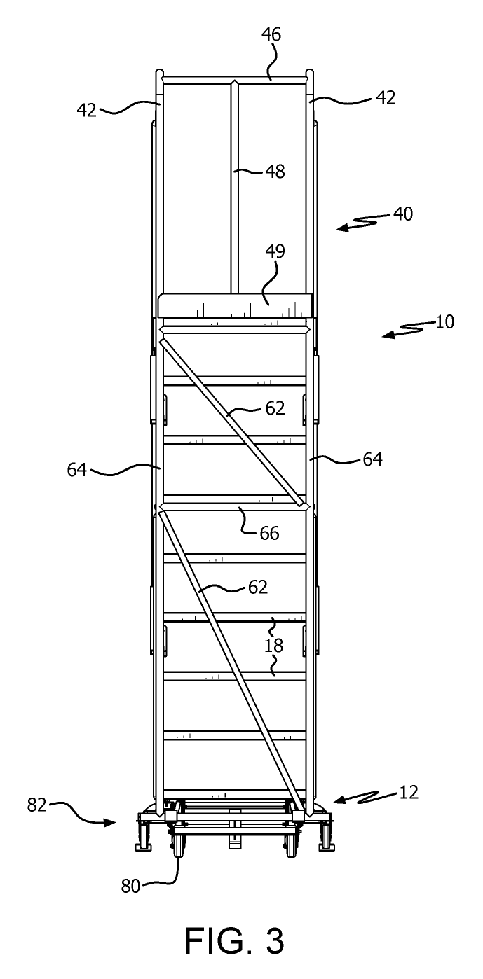

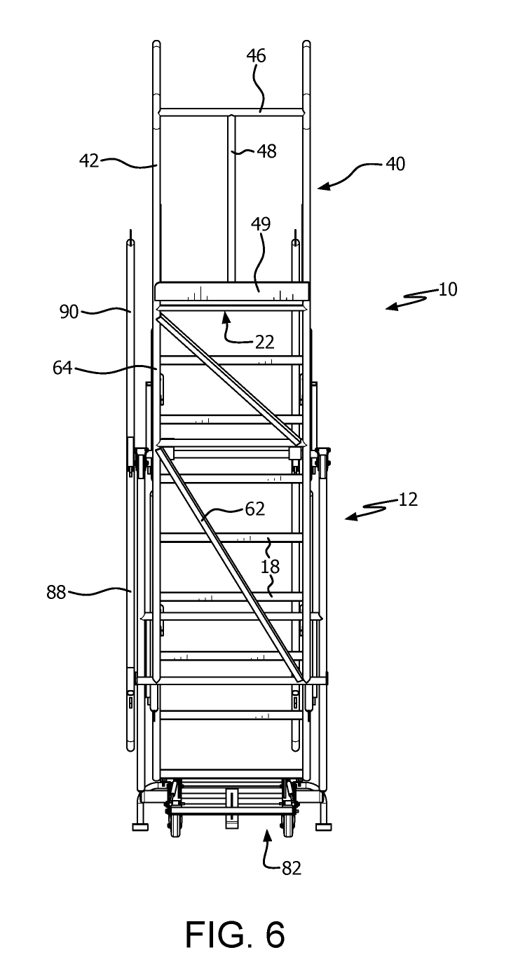

In FIGS. 1 through 6 there is shown a preferred embodiment of a rolling ladder 10 in accordance with the present invention. The ladder 10 has a modular design which facilitates disassembly for shipping in compact containers, yet which can be easily assembled by an end user. Preferably, the ladder 10 is manufactured in accordance with ANSI 14.7

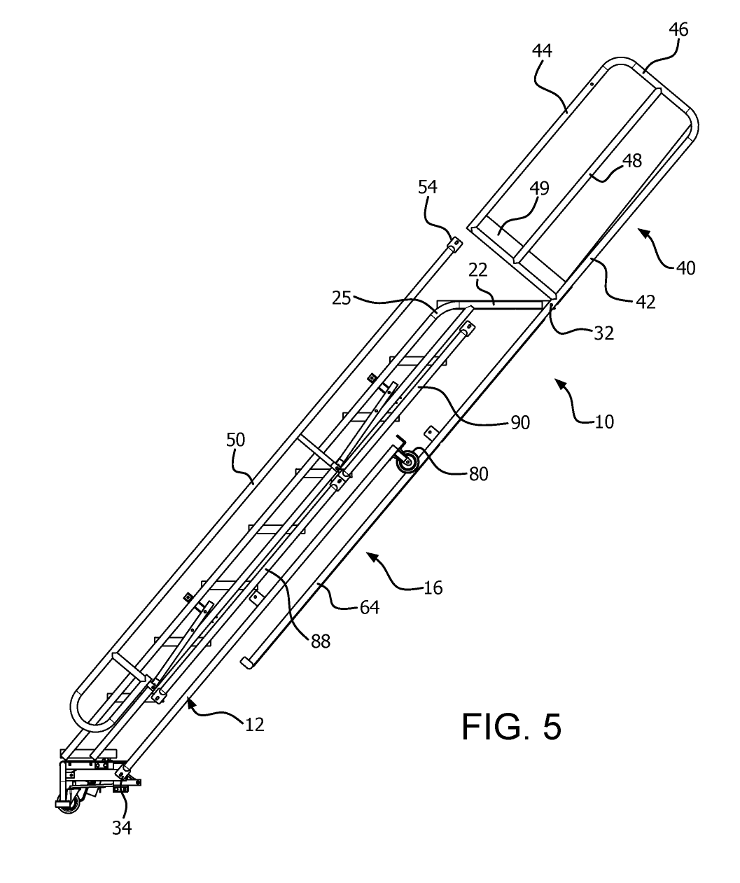

In particular, as best seen in FIG. 5, the cross-braces are configured to be removably detached from the remainder of the ladder to facilitate folding the ladder and placing it in a compact shipping container (not shown) or otherwise storing it. Due to the large size of the assembled ladder 10 the size of the shipping container would have to be greatly increased in height in order to cover the full height of the ladder. Being able to ship the ladder 10 in a more compact shipping container increases the number of ladders which can be fit into a standard cargo container.

Returning to FIGS. 1 to 3, the ladder 10 comprises a base 12, a stair section 14 attached at its bottom end to the front end of the base. A vertical support 16 connects the top end of the stair section 14 to the back end of the base 12.

The stair section 14 includes a plurality of treads 18 attached to a pair of end rails or stringers 20 forming the stair section. Treads are also referred to herein as stairs or steps. The stair section 14 preferably has an elongated parallelogram shape. Preferably, the stair section 14 comprises a substantially one-piece assembly. Preferably, the treads 18 are fixedly attached to the stringers 20 via any suitable means, such as by welding, riveting or the like. The stringers 20 each comprise a top rail 21 and a bottom rail 23. Top rail 21 has a curved portion 25.

The top step or tread 22 is attached to the top rail 21 of the end stringers 20 adjacent the curved portion 25. The top step 22 is also detachably attached to the end of the bottom rail 23, as described in greater detail below. The depth of the top step 22 may be deeper than the remaining steps or treads 18 to facilitate the standing or supporting of an end user or other material to be supported. Typically, the depth of the top step 22 is in the range of about 100% to 300% deeper than the treads 18.

The ladder 10 may also include top step handrails 40 which encircle the top step on the sides and back. Back hand rail 42 is typically the top of vertical supports 16 and a rear guardrail 30. A front handrail 44 is also provided and connects to the back handrail via a connecting top handrail 46. An intermediate rail 48 may also be provided for extra stability and safety. A footguard 49 is also provided adjacent the top step 22 around the periphery thereof. The back, front, and intermediate handrails 42, 44, and 46, respectively are fastened to a bottom rail 47 which also extends around the top step 22 adjacent the foot guard 49.

A second pair of handrails 50 are connected to the stair section 14 via connecting rails 52 which attach to the top 21 and bottom 23 rails of the stringer 20 via brackets and using suitable fasteners, such as bolts and locknuts. The end 54 of the handrail 20 is attached to upright rail 44 using suitable fasteners as well.

Casters 80 may also be attached to each side of the vertical support frame 16 or base 12 to facilitate the mobility of the ladder 10. The term casters as used herein includes casters, wheels, balls or any other rolling device. The front of the ladder may be provided with a locking step assembly 82 which permits travel of the ladder of the ladder as well as for providing a non-rolling support when desired.

The rear vertical support 16 comprises a cross brace 62 which connects two upright vertical rails 64, as well as a horizontal cross rail 66.

Base 12 comprises a pair of side rails 68 and 72 connected be an intermediate cross rail 74 and a back cross rail 76.

Vertical braces 88 and horizontal braces 90 are included to further stabilize and support the stair assembly 14 in use. One end 92 of the horizontal braces 90 is attached to the vertical rail 64 via a bracket and at the opposite end 94 to another bracket attached to the bottom rail 23 of the stringer 20. One end 96 of the vertical braces 88 is attached to the bottom rail 23 of the stringer 20 and via a bracket and at the opposite end 98 to another bracket attached to the bottom cross rail 74 of the base 12. The design of the vertical braces 88 and horizontal braces 90 may be used on many different size ladders in both stairway slope 50 degrees and ladder slope 59 degrees.

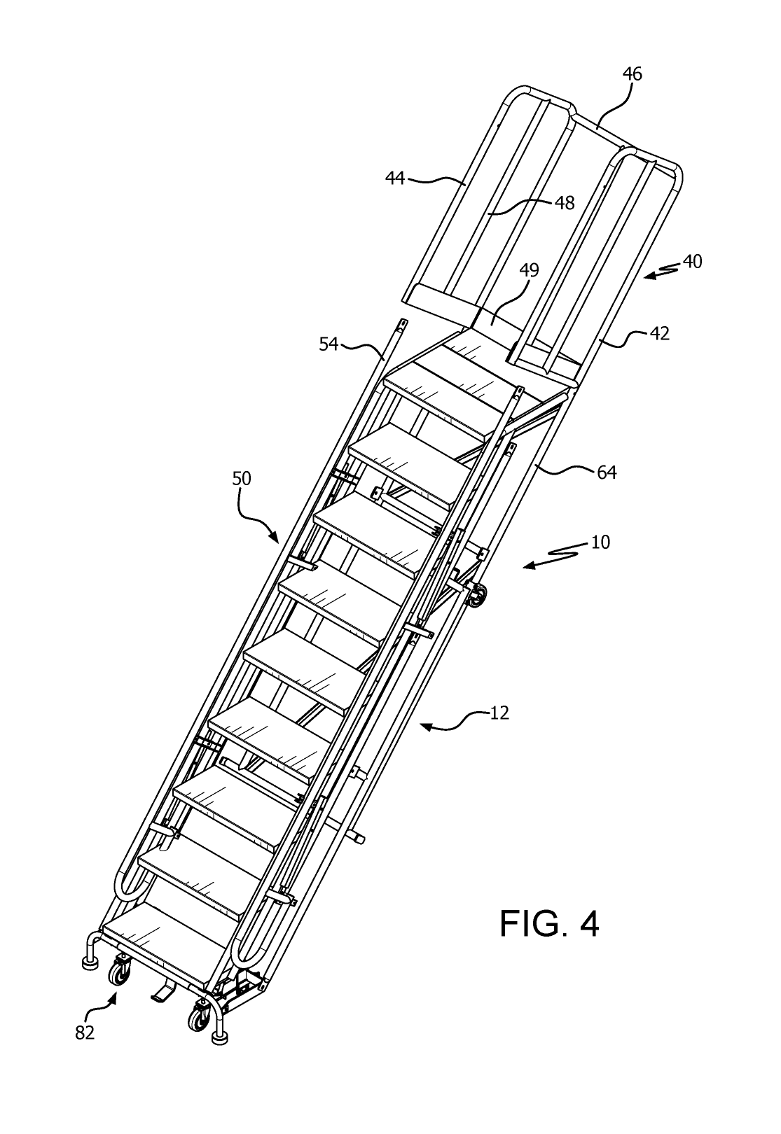

The combination rear vertical 64 and the upper rails 40 pivot at the top step 22, allowing the ladder 10 to fold for shipping, as best seen in FIG. 4 through 6. The connection between the base 12 and vertical 16 does not require bolts. These parts nest together and stay in place once the bracing and hand rails are connected. The fold down handrails 50 simply rotate into place and connect to the upper rail system 40 at front rail 44.

In order to fold the ladder, the top rail assembly 40 is detached from the end 54 of handrail 50. This permits the top step to pivot about pivot point 32. Similarly, the connections of rails 52 may be loosened to allow the handrails 50 to pivot downwardly into a more compact configuration. Rails 88 are detached at points 98 and rails 90 are detached at points 92. Since rails 88 and 90 are pivotably attached at points 96 and 94 respectively, the rails 88 and 90 may be pivoted to be flush with the stringer 20. This permits the bottom of vertical upright section 16 and handrail assembly 40 to be pivoted upwardly at pivot 32 and the rear of base 12 to be pivoted upwardly about point 34 as best seen in FIGS. 4 through 6.

The benefits of this new design include the ability to ship in a compact container reducing freight cost and freight damage, may be assembled in less than 5 minutes with only 6 bolts to install, and since the base 12 and the vertical 16 are not bolted directly together they can float allowing the ladder 10 to absorb up to ¼″ of uneven floors without wobbling.

Similarly, ladders with additional steps/treads above the removable step are also within the scope of the claimed invention, even though the removable step is often described as the “upper” or “top” step herein.

In the preferred embodiment the entire ladder assembly, or a substantial portion thereof, is made out of metal, preferably steel or stainless steel.

While in the preferred embodiments described herein the ladder is a rolling ladder, the invention applies equally to any stationary ladders. Likewise, while the stair section has been described as having the steps/treads welded or riveted in place, these lower steps may be held in place through any convenient method (bolts, etc.) or made of a single piece of metal. Likewise, these lower treads may also be removable and be within the scope of the invention.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A folding ladder for use with a compact container comprising:
a stair section assembly comprising a plurality of steps connected between two parallel stringer sections, the stair section assembly having a front end and a back end;
a base having casters, the base being pivotably attached to the front end of the stair section;
a vertical upright support pivotably attached to the back end of the stair section a one end and non-securedly attached to the base at an opposite end;
a first brace pivotably attached to the stair section at one end and detachably secured at the vertical upright support at an opposite end; and
a second brace pivotably attached to the stair section at one end and detachably secured at the base at an opposite end,
whereby the ladder may be folded into a compact configuration for shipping or storage.

2. The folding ladder in accordance with claim 1 wherein the vertical upright support further comprises a handrail assembly at its top end which interacts with a top step of the stair section.

3. The folding ladder in accordance with claim 2 wherein the stair section further comprises a foldable handrail which attaches to the handrail assembly.

4. The folding ladder in accordance with claim 1 wherein the connection between the base and vertical does not include fasteners.

5. The folding ladder in accordance with claim 3 wherein the connection between the base and vertical does not include fasteners.

6. The folding ladder in accordance with claim 1 wherein the base and vertical upright support nest together and stay in place once the first and second rails are fixedly connected.

7. The folding ladder in accordance with claim 3 wherein the base and vertical upright support nest together and stay in place once the first and second rails are fixedly connected.

8. The folding ladder in accordance with claim 1 wherein the fold-down handrails rotate into place and connect to the handrail assembly.

9. The folding ladder in accordance with claim 3 wherein the fold-down handrails rotate into place and connect to the handrail assembly.

10. The folding ladder in accordance with claim 1 wherein the stair section further comprises a locking bottom step and the top step has a wider depth relative to the remaining steps.

11. The folding ladder in accordance with claim 3 wherein the stair section further comprises a locking bottom step and the top step has a wider depth relative to the remaining steps.
